(19) United States
(12) Patent Application Publication
(10) Pub. No.: US 2026/0082347 A1
(43) Pub. Date: Mar. 19, 2026

(54) SYSTEMS, METHODS, AND APPARATUSES FOR ENABLING MULTIPLE TIMING ADVANCES FOR MULTIPLE TRANSMISSION RECEPTION POINTS IN WIRELESS COMMUNICATION

(71) Applicant: APPLE INC., Cupertino, CA (US)

(72) Inventors: Hong He, San Jose, CA (US); Haitong Sun, Cupertino, CA (US); Chunhai Yao, Beijing (CN); Dawei Zhang, Saratoga, CA (US); Chunxuan Ye, San Diego, CA (US); Wei Zeng, San Diego, CA (US); Jie Cui, San Jose, CA (US); Ankit Bhamri, Bad Nauheim (DE); Seyed Ali Akbar Fakoorian, San Diego, CA (US); Sigen Ye, San Diego, CA (US)

(21) Appl. No.: 19/107,428

(22) PCT Filed: Sep. 23, 2022
(86) PCT No.: PCT/CN2022/120951

§ 371 Date: Feb. 27, 2025

(51) Int. Cl. H04W 56/00; H04W 28/06

(52) U.S. Cl. CPC H04W 56/0045; H04W 28/06

(57) ABSTRACT

Systems, methods, and apparatuses for enabling multiple timing advances (TAs) for multiple transmission reception points (TRPs) are disclosed herein. In embodiments, a UE may perform timing advance group (TAG) association for different uplink (UL) transmissions for mTRP use, where a pair of inter-frequency TAGs respectively corresponding to a pair of TRPs is used by the UE for determining TAs for UL transmissions to each TRP. In embodiments, a UE performs downlink (DL) reference timing determinations for two TAs for mTRP use, with such determinations being based on one or more aspects of one or more active transmission 2024/060217 configuration indicators (TCI) usable for UL at the UE. In embodiments, a LIE handles cases of overlapped UL transmissions on two respective UL panels due to the use of two TAs corresponding to a pair of TRPs. Network behavior and signaling corresponding to these aspects is also discussed.

### TECHNICAL FIELD

This application relates generally to wireless communication systems, including wireless communication systems for UEs that operate with multiple TRPs.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a template for a TAG configuration, according to embodiments herein.

FIG. 2 illustrates a diagram corresponding to uses of TAG configurations in an UL mTRP case, according to embodiments herein.

FIG. 3, illustrates a method of a UE for handling TAT timer expiration, according to embodiments herein.

FIG. 4 illustrates a template for a configuration for a CG that implements an RRC-based HARQ-buffer sharing indication, according to embodiments herein.

FIG. 5 illustrates templates for TCI state configurations that include TAG-IDs according to embodiments herein.

FIG. 6 illustrates a template for a TAG configuration that shows that that a TAG configuration may include a coresetPoolIndex value for the corresponding TAG, according to embodiments herein.

FIG. 7 illustrates a table providing an example of TAG association corresponding to a number of TCI states, according to embodiments herein.

FIG. 8 illustrates a method of a UE, according to embodiments herein.

FIG. 9 illustrates a method of a RAN, according to embodiments herein.

FIG. 10 illustrates a table showing information corresponding to various alternatives for determining DL reference timing for a TA command, according to embodiments herein.

FIG. 11 illustrates a method of a UE, according to embodiments herein.

FIG. 12 illustrates a method of a UE, according to embodiments herein.

FIG. 13 illustrates a method of a UE, according to embodiments herein.

FIG. 14A illustrates a diagram showing a manner of dropping data of a UL transmission in the case of an overlap between slots for two UL transmissions at different UL panels of the UE, according to embodiments herein.

FIG. 14B illustrates a diagram showing a manner of dropping data of a UL transmission in the case of an overlap between slots for two UL transmissions at different UL panels of the UE, according to embodiments herein.

FIG. 15 illustrates a method of a UE, according to embodiments herein.

FIG. 16 illustrates a method of a UE, according to embodiments herein.

FIG. 17 illustrates a method of a RAN, according to embodiments herein.

FIG. 18 illustrates a method of a RAN, according to embodiments herein.

FIG. 19 illustrates an example architecture of a wireless communication system, according to embodiments disclosed herein.

FIG. 20 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

New mobile services corresponding to low-latency and high reliability performance use cases (e.g., ultra-reliable low latency communications (URLLC)) are emerging. Accordingly, enhancement of wireless communications systems (e.g., wireless communications systems implementing the 5G standard) for mobility robustness and performance within such scenarios is beneficial.

Uplink (UL) timing enhancements that further these goals may accordingly be beneficial. It has been determined that multiple-input multiple-output (MIMO) evolutions for downlink (DL) and UL may specify cases where two timing advances (TAs) in UL for multiple downlink control information (DCI) (mDCI) for multiple transmission reception point (TRP) (mTRP) may be used. Additionally, it has been determined that such MIMO evolutions may specify mechanisms and procedures of layer 1 (L1)/layer 2 (L2) based inter-cell mobility for mobility latency reduction, such as TA management mechanisms and procedures in such cases.

It may be that the UE is configured with a pair of timing advance groups (TAGs). A first of the TAGs may be associated with UL communication by the UE to a first TRP, and a second of the TAGs may be associated with UL communication by the UE to a second TRP. In some cases, the UL communication to the first TRP is performed by the UE using a first UL panel of the UE, and the UL communication to the second TRP is performed by the UE using a second UL panel of the UE.

Each of the pair of TAGs may be associated with the use of a same frequency to communicate with its respective TRP. Herein, such TAGs that are associated with the use of that same frequency may be referred to as “intra-frequency TAGs.” When performing an UL transmission using the frequency corresponding to the two intra-frequency TAGs configured at the UE for two different TRPs, the UE may identify one of the two TAGs as associated with the UL transmission and perform the UL transmission according to that TAG. This causes the UL transmission to be configured appropriately for reception at the TRP for that TAG.

Each of the first TAG and the second TAG may use (e.g., different) TA values (e.g., corresponding to different distances of the UE from each of the TRPs). Accordingly, a first UL transmission that is for the first TRP may be sent with a timing that is determined using a first TA value for the first TAG, and a second UL transmission that is for the second TRP may be sent with a timing that is determined using a second TA value for the second TAG.

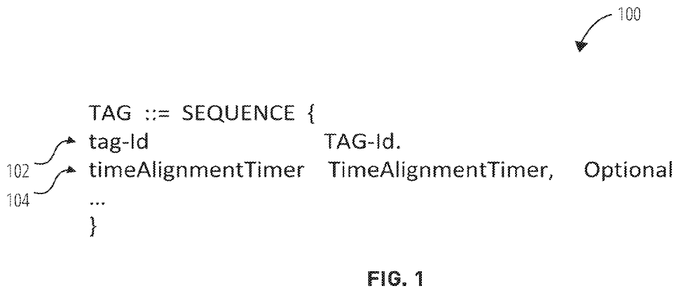

A TAG may be understood/defined at the UE (at least in part) according to a TAG configuration for the TAG that is provided by the network to the UE. FIG. 1 illustrates a template 100 for a TAG configuration, according to embodiments herein. Note that the template 100 may be a template for, for example, an ASN.1 configuration used by the UE. The template 100 illustrates that a TAG configuration may include a dedicated TAG identifier (TAG-ID) 102 for the corresponding TAG and one or more time alignment timer (TAT) value(s) 104 used corresponding to that TAG that identifies a length of time for which a TA corresponding to the TAG is valid.

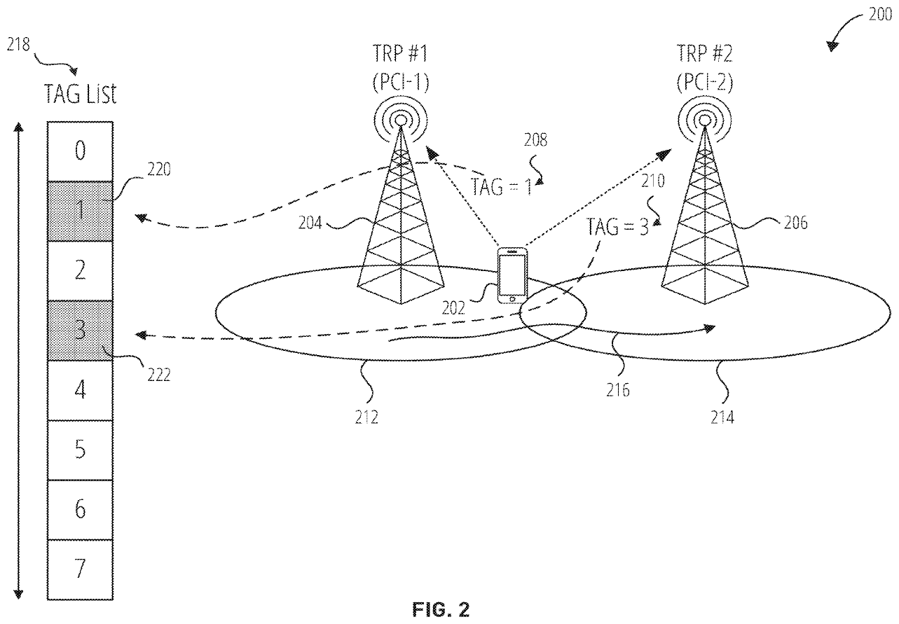

FIG. 2 illustrates a diagram 200 corresponding to uses of TAG configurations in an UL mTRP case, according to embodiments herein. The diagram 200 illustrates a UE 202 that performs UL communications with a first TRP 204 associated with a first TAG 208 and with a second TRP 206 associated with a second TAG 210 that is an intra-frequency TAG with the first TAG 208.

Embodiments discussed herein may relate to intra-frequency TAG use toward multiple TRPs in either an inter-cell case and/or an inter-cell case. In an inter-cell case, the UE connects to each of the TRPs (on the same frequency) on different cells (e.g., having different physical cell identities (PCIs)). FIG. 2 illustrates such an inter-cell case, because the UE 202 connects with the first TRP 204 on a first cell 212 having a first PCI (“PCI-1” in FIG. 2), while the UE further connects with the second TRP 206 on a second cell 214 having a second PCI (“PCI-2” in FIG. 2).

In an intra-cell case, the UE connects/is connected to each of the TRPs on the same cell (e.g., each of the TRPs broadcast a same cell (having a same PCI) for the UE's use).

Unless the particular context of a described embodiment makes it otherwise clear, it should be understood that discussion herein may applied in both the inter-cell and intra-cell cases.

FIG. 2 illustrates that the first TAG 208 is undergoing mobility 216 relative to the first TRP 204 and the first TAG 208. In inter-cell cases, it may be that communications with one of the TRPs occur on a “serving cell,” which may be a cell to which a UE is has been/is already connected (e.g., prior to/unrelated to any mobility). Further, in such inter-cell cases, it may be that communications with the other of the TRP occur on a “non-serving cell,” which may be a cell to which the UE is initiating a new connection (e.g., attendant the new cell as broadcast by this second TRP coming within range due to mobility). Accordingly, relative to the inter-cell case illustrated in FIG. 2, and assuming an existing connection with the first TRP 204 on the first cell 212, as the UE 202 experiences the mobility 216 it initiates (another) connection with the second TRP 206 on the second cell 214 corresponding to mTRP use as described herein. Under such circumstances, the first cell 212 would be understood to be a “serving cell” while the second cell 214 would be understood to be a “non-serving cell.”

### TAG Association for Different UL Transmission for mDCI mTRP

A first issue that arises when using two TAs for UL mDCI mTRP relates to the manner of allowing for different TAs for UL transmissions toward different TRPs. For example, a manner of determining the TA values for different UL transmissions towards the different TRPs may need to be defined.

Embodiments herein accomplish the association of a TA value to a UL transmission in the mTRP case via the use of TAGs. Accordingly, various aspects related to the association between UL transmission(s) and corresponding intra-frequency TAG(s) (e.g., where each intra-frequency TAG uses a corresponding (e.g., different) TA) are now discussed.

In some embodiments, a UE may be provided with a TAG list by radio resource control (RRC) signaling from the network. The TAG list may include TAG configurations for TAGs that correspond to cells of a cell group (e.g., a master cell group (MCG) or a serving cell group (SCG)).

In some designs, a maximum number of TAG configurations indicated in a TAG list maybe larger than four. For example, in some cases, (up to) eight TAG configurations may be indicated in a TAG list. It is noted that the use of (up to) eight TAG configurations in a TAG list may be improved from prior wireless communication systems, which may allow, for example, only (up to) four such TAG configurations.

A UE capability maybe introduced that indicates the maximum number of TAGs supported by a UE. The UE may indicate this capability to the network in a UE capability message. In some designs, the network accordingly limits the number of TAG configurations sent in a TAG list to less than or equal to the UE capability as indicated.

Multiple options may be considered for the configuration of TATs for the TAG configurations of the TAG list for a pair of intra-frequency TAGs. In a first option, two separate timeAlignmentTimer parameters for individual (e.g., different) TATs may be configured in the TAG configurations of the TAG list for two intra-frequency TAGs, such that one of the intra-frequency TAGs uses one of the TATs and the other of the intra-frequency TAGs uses the other of the TATs.

In a second option, a single timeAlignmentTimer parameter having a TAT may be configured by RRC signaling explicitly in a TAG configuration of the TAG list for one of the two intra-frequency TAGs. Based on this explicit indication for a TAT for one of the intra frequency TAGs, the UE may use the (same) TAT for the other of the intra-frequency TAGs.

In the embodiment of FIG. 2, the UE 202 has been configured by the network with the TAG list 218. As illustrated, (up to) eight TAG configurations maybe configured for the UE 202 in the TAG list 218, (e.g., subject to a UE capability of the UE 202 as discussed herein). FIG. 2 accordingly illustrates that the TAG list 218 has eight TAG configurations, indexed from 0 to 7.

As illustrated, the first TAG 208 corresponds to the index 1 TAG configuration 220 of the TAG list 218 and the second TAG 210 corresponds to the index 3 TAG configuration 222, which are in this case intra-frequency TAGs. The index 1 TAG configuration 220 and the index 3 TAG configuration 222 may have been selected based on communications between the UE and the network.

In some embodiments, as is discussed herein, it may be that each of the index 1 TAG configuration 220 and the index 3 TAG configuration 222 is configured with an individual TAT. Accordingly, the UE 202 uses the TAT given in the index 1 TAG configuration 220 with a TA mechanism for UL transmissions according to the first TAG 208 to the first TRP 204.

Further, the UE 202 uses the TAT given in the index 3 TAG configuration 222 with a TA mechanism for UL transmissions according to the second TAG 210 to the second TRP 206.

In other cases, as is discussed herein, the network may configure one of the index 1 TAG configuration 220 for the first TAG 208 and the index 3 TAG configuration 222 for the second TAG 210 with an explicit TAT for use with a TA mechanism for UL transmissions according to the first TAG 208 to the first TRP 204. Then, based on the fact that the first TAG 208 and the second TAG 210 are intra-frequency TAGs, the UE 202 then applies the use of the same TAT with a TA mechanism for UL transmissions according to the second TAG 210 to the second TRP 206. The use of such an implicit method (for at least one of the TAGs) may minimize the signaling overhead relative to cases where multiple TATs are explicitly indicated.

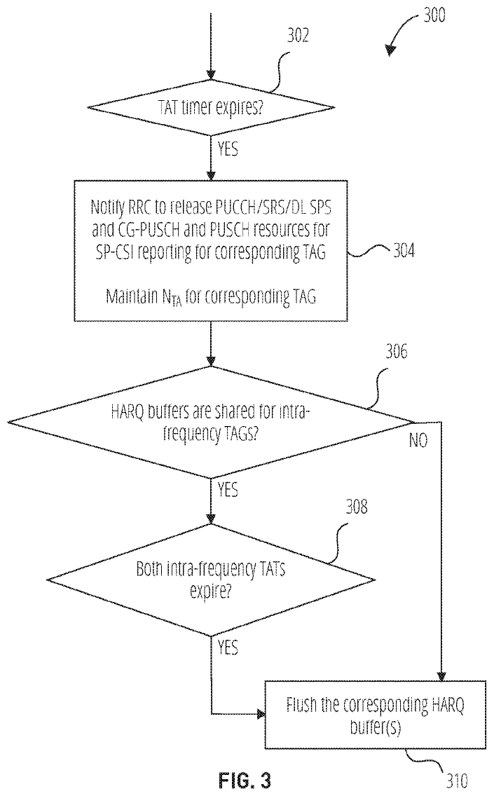

Various options for UE behavior when one or more TAT timer(s) expires are now discussed. FIG. 3, illustrates a method 300 of a UE for handling TAT timer expiration, according to embodiments herein.

When a TAT corresponding to a TAG expires 302, the UE may notify 304 the network (e.g., via RRC) to release any physical uplink control channel (PUCCH)/sounding reference signal (SRS)/DL semi-persistent scheduling (SPS) resources and any configured grant (CG) physical uplink shared channel (PUSCH) and/or PUSCH resources for semi-persistent channel state information (SP-CSI) reporting corresponding to that TAG. A TA value (e.g., an N_{TA} value) corresponding to the TAG may be maintained at the UE.

Additionally, hybrid automatic repeat request (HARQ) buffers of the serving cell may be handled at the UE as follows when the TAT for the TAG expires. In a first case, the UE determines 306 that the HARQ buffers are shared between this TAG and a second intra frequency TAG to the TAG as associated with two UL panels. The use of such shared HARQ buffers may correspond to a case where a single (same) distributed unit (DU) corresponds to each TRP, such that a backhaul (BH) for the first TRP and the second TRP is effectively ideal as between the TRPs. In the case that shared HARQ buffers are being used, the UE then checks 308 whether both of the TAT timers have expired (e.g., the UE checks 308 whether a second TAT corresponding to the intra-frequency TAG to this TAG has also expired). If both TATs (for each intra-frequency TAG) have expired, the UE flushes 310 the shared HARQ buffers for each of the TAGs.

In a second case, the UE determines 306 that the HARQ buffers are not shared between this TAG and a second intra-frequency TAG to the TAG as associated with two UL panels. The use of separate HARQ buffers may correspond to a case where a different DU corresponds to each TRP, such BH characteristics applicable to the first TAG are not the same as BH characteristics applicable to the second TAG. In this case, the UE flushes 310 the HARQ buffer that corresponds to the TAG of the expired TAT timer (on an individual basis).

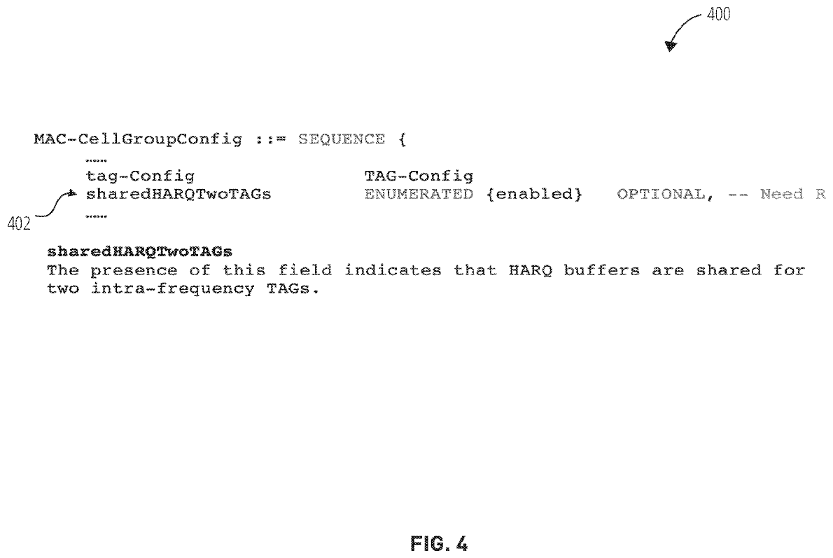

In some cases, whether HARQ buffers for two intra-frequency TAGs are shared or not may be explicitly configured by RRC signaling from the network to the UE on a per cell group basis. FIG. 4 illustrates a template 400 for a configuration for a cell group that implements an RRC-based HARQ-buffer sharing indication, according to embodiments herein. Note that the template 400 may be a template for, for example, an ASN.1 configuration used by the UE. The template 400 provides a sharedHARQTwoTAGs indication 402 that, as illustrated in FIG. 4, indicates whether HARQ buffers are shared for two intra-frequency TAGs.

Alternatives used by the UE to associate a TAG configuration for a TAG from the TAG list to a particular UL transmission to a TRP (such that the UL transmission is sent according to that TAG) are now discussed.

In a first alternative, it may be that a UL transmission at the UE is associated with a transmission configuration indicator (TCI) state that is to be used for that UL transmission. For example, a UL transmission may be associated with one of a joint UL/DL TCI state and/or an UL TCI state that controls aspects of the UL transmission. Such TCI states may have been previously configured to/activated at the UE. In some cases, the TCI state to be used for the UL transmission is indicted by a DCI format that schedules the UL transmission.

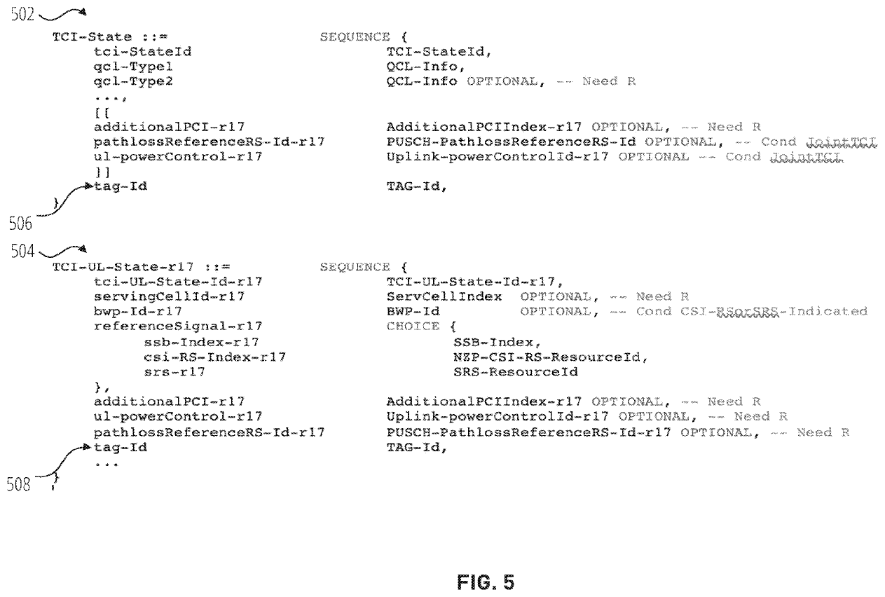

For each joint UL/DL or UL TCI state, a TAG-ID associated with one of the two intra-frequency TAGs may be explicitly provided by RRC signaling from the network to the UE. FIG. 5 illustrates templates 502, 504 for TCI state configurations that include TAG-IDs according to embodiments herein.

The first template 502 corresponds to a configuration for a joint UL/DL TCI state, and illustrates that the configuration for the joint UL/DL TCI state may include a TAG-ID 506. Note that the first template 502 may be a template for, for example, an ASN.1 configuration used by the UE. In the case that the UE identifies that the UL transmission is to be sent according to a joint UL/DL TCI state that is configured with a TAG-ID 506, the UE associates the UL transmission with the TAG corresponding to the TAG-ID 506.

The second template 504 corresponds to a configuration for a UL TCI state, and illustrates that the configuration for the UL TCI state may include a TAG-ID 508. Note that the second template 504 may be a template for, for example, an ASN.1 configuration used by the UE. In the case that the UE identifies that the UL transmission is to be sent according to a UL TCI state that is configured with a TAG-ID 508, the UE associates the UL transmission with the TAG corresponding to the TAG-ID 508.

Note that in some cases, in order to address a TAG number limitation at the UE, a single TAG-ID may be configured for all non-serving cells (since in such cases only one of the TCI states for seven non-serving cells can be activated).

Once the TAG associated with the TCI state of the UL transmission is determined, the UE adjusts the uplink timing for the UL transmission (e.g., a PUSCH/SRS/PUCCH transmission) based on the TA value for this corresponding TAG.

In a second alternative, it may be that control resource sets (CORESETs) used by the UE (e.g., to receive physical downlink control channels (PDCCHs)) are associated with different CORESET pools corresponding to respective coresetPoolIndex values. In such cases, a UE may be provided with a coresetPoolIndex value of ‘0’ or ‘1’ corresponding each TAG configuration by RRC signaling.

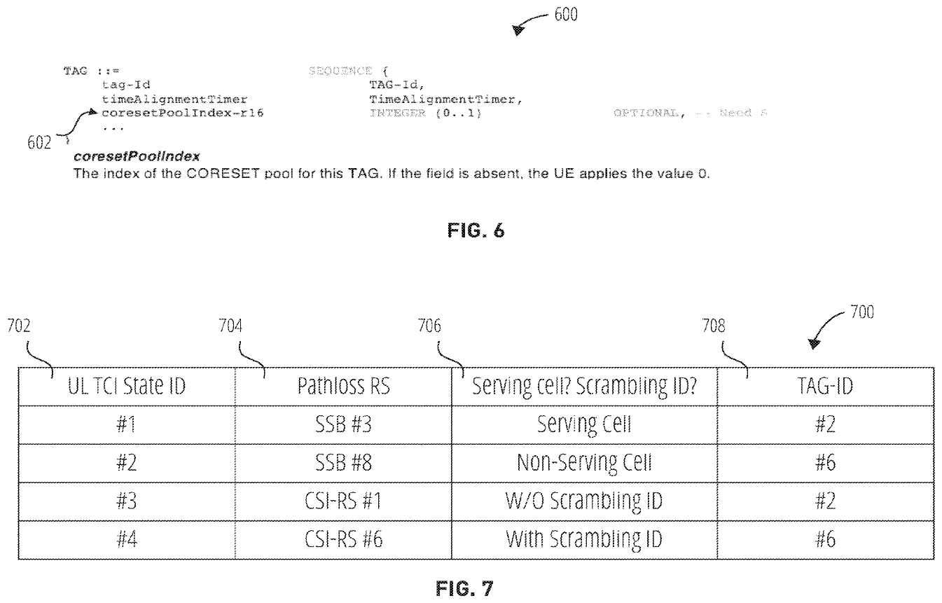

FIG. 6 illustrates a template 600 for a TAG configuration that shows that that a TAG configuration may include a coresetPoolIndex value 602 for the corresponding TAG, according to embodiments herein. Note that the template 600 may be a template for, for example, an ASN.1 configuration used by the UE. The template 600 may be a further-specified version of the template 100 of FIG. 1, as discussed herein.

Then, in the case of a UL transmission that is scheduled by a UL grant, the UE uses the TA of the TAG associated with the same value of coresetPoolIndex as the CORESET where the UE detects a DCI format carrying the UL grant in a monitored search space.

In the case of a UL transmission without a UL grant (e.g., a Typel CG-PUSCH, or PUCCH resource for periodic channel state information (P-CSI)/SP-CSI/periodic sounding reference signal (P-SRS)), the associated coresetPoolIndex value to use corresponding to such transmissions may be indicated by RRC signaling (e.g., a configuration provided by RRC signaling). Alternatively, a TAG-ID corresponding to such transmissions maybe provided by RRC signaling (e.g., a configuration provided by RRC signaling), and the TA of that TAG is then used.

Note that in some cases (and as illustrated in FIG. 6) a default coresetPoolIndex value (e.g., ‘0’) may be assumed to be the applicable coresetPoolIndex for a TAG if the coresetPoolIndex field is not present in a TAG configuration for the TAG. Under such circumstances, it may be that an explicit indication of coresetPoolIndex may be intentionally dropped/not used by the network in TAG configurations for which the default coresetPoolIndex applies in order to minimize signaling overhead.

Once the TAG associated with the applicable coresetPoolIndex is determined, the UE adjusts the uplink timing for the UL transmission (e.g., a PUSCH/SRS/PUCCH transmission) based on the TA value for this corresponding TAG.

In a third alternative, it may be that the UE identifies the TAG associated with a UL transmission based on a pathloss (PL) reference signal (RS) of an indicated TCI state. As described herein, a UE may be configured with various TCI states (joint UL/DL TCI states, UL TCI states) that may be used to determine characteristics for a UL transmission. Such TCI states may indicate a PL RS that is associated with that TCI state.

For the UL transmission, as between the two intra-frequency TAGs, the TAG with larger TAG-ID is associated with the UL transmission in the case, for example, that the PL RS of the TCI state for the UL transmission is either a synchronization signal block (SSB) associated with a non-serving cell or a channel state information reference signal (CSI-RS) with a scrambling identifier (ID) configured by RRC signaling that is different from a scrambling ID used by the PCI of a serving cell. Otherwise, the TAG with the smaller TAG-ID is associated with the UL transmission.

FIG. 7 illustrates a table 700 providing an example of TAG association corresponding to a number of UL TCI states 702, according to embodiments herein. Assume that two intra-frequency TAGs used at the UE to communicate with two TRPs are configured by RRC signaling as TAG #2 and TAG #6.

Further assume that four UL TCI states 702 usable for UL transmissions are configured to/activated at the UE. It will be understood that, in other embodiments, one or more of the UL TCI states 702 could instead be joint UL/DL TCI states, as have been described.

By comparing the UL TCI states 702, the PL RSs 704, and the PL RS information 706 in the table 700, it can be seen that the PL RS of UL TCI state #1 is an SSB of a serving cell, the PL RS of UL TCI state #2 is an SSB of a non-serving cell, the PL RS of UL TCI state #3 is a first CSI-RS that does not use a scrambling ID that is different from a scrambling ID used by a PCI of a serving cell, and the PL RS of UL TCI state #4 is a second CSI-RS that uses a scrambling ID that is different from the scrambling ID used by a PCI of a serving cell.

Under such circumstances, using the example rules given above, UL TCI state #1 is associated with the TAG with the smaller ID (TAG #2, as illustrated in the TAG-ID information 708) because its PL RS is an SSB of the serving cell. Accordingly, a UL transmission that uses UL TCI state #1 is associated with TAG #2.

Further, UL TCI state #2 is associated with the TAG with the larger ID (TAG #6, as illustrated in the TAG-ID information 708) because its PL RS is an SSB of a non-serving cell. Accordingly, a UL transmission that uses UL TCI state #2 is associated with TAG #6.

Further, UL TCI state #3 is associated with the TAG with the smaller ID (TAG #2, as illustrated in the TAG-ID information 708) because its PL RS is a CSI-RS that is does not have a scrambling ID that is different from the PCI of the serving cell. Accordingly, a UL transmission that uses UL TCI state #3 is associate with TAG #2.

Finally, UL TCI state #4 is associated with the TAG with the larger ID (TAG #6, as illustrated in the TAG-ID information 708) because its PL RS is a CSI-RS that has a scrambling ID that is different from the PCI of the serving cell. Accordingly, a UL transmission that uses UL TCI state #4 is associated with TAG #6.

Accordingly, for a UL transmission, the UE can identify the TAG that corresponds to the one of the UL TCI states 702 used by the UL transmission. Accordingly, the UE adjusts the uplink timing for the UL transmission (e.g., a PUSCH/SRS/PUCCH transmission) based on the TA value for this corresponding TAG.

The rules applied in relation to the example FIG. 7 are given by way of example and not by way of limitation. For example, in other embodiments, it may be that as between two intra-frequency TAGs, the TAG with smaller TAG-ID is associated with a UL transmission in the case that the PL RS of the TCI state for the UL transmission is either an SSB associated with a non-serving cell or a CSI-RS with a scrambling ID configured by RRC signaling that is different from the PCI of the serving cell, and that otherwise the TAG with the larger TAG-ID is associated with the UL transmission.

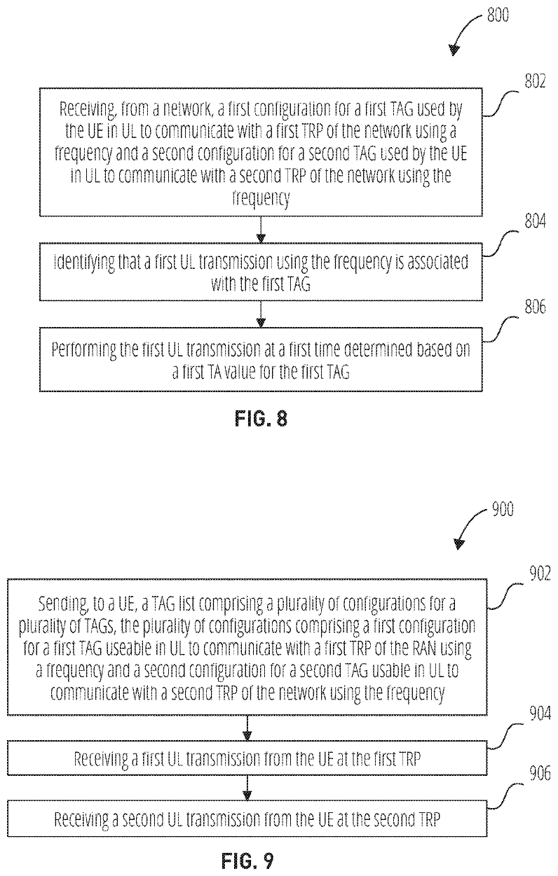

FIG. 8 illustrates a method 800 of a UE, according to embodiments herein. The method 800 includes receiving 802, from a network, a first configuration for a first TAG used by the UE in UL to communicate with a first TRP of the network using a frequency and a second configuration for a second TAG used by the UE in UL to communicate with a second TRP of the network using the frequency.

The method 800 further includes identifying 804 that a first UL transmission using the frequency is associated with the first TAG.

The method 800 further includes performing 806 the first UL transmission at a first time determined based on a first TA value for the first TAG.

In some embodiments, the method 800 further includes identifying that a second UL transmission using the frequency is associated with the second TAG and performing the second UL transmission at a second time determined based on a second TA value for the second TAG.

In some embodiments of the method 800, the first configuration for the first TAG and the second configuration for the second TAG are received in a TAG list comprising a plurality of configurations for a plurality of TAGs that includes the first TAG and the second TAG. In some such embodiments, the method 800 further includes sending, to the network, a UE capability message indicating a maximum number of the plurality of TAGs that can be supported by the UE.

In some embodiments of the method 800, the first configuration for the first TAG comprises a first time alignment timer for the first TAG, and the second configuration for the second TAG comprises a second time alignment timer for the second TAG.

In some embodiments of the method 800, the first configuration for the first TAG comprises a first time alignment timer for the first TAG, and the method 800 further includes determining that the first time alignment timer is also used for the second TAG.

In some embodiments, the method 800 further includes identifying that a first HARQ buffer of the UE and a second HARQ buffer of the UE are shared across the first TAG and the second TAG, determining that a first time alignment timer for the first TAG has expired and that a second time alignment timer for the second TAG has expired, and flushing each of the first HARQ buffer and the second HARQ buffer in response to the determining that the first time alignment timer for the first TAG has expired and that the second time alignment timer for the second TAG has expired.

In some embodiments, the method 800 further includes identifying that a first HARQ buffer of the UE and a second HARQ buffer of the UE are not shared across the first TAG and the second TAG, determining that a time alignment timer for the first TAG has expired, and flushing the first HARQ buffer in response to the determining that the time alignment timer for the first TAG has expired.

In some embodiments of the method 800, the identifying that the first UL transmission is associated with the first TAG comprises determining that a TAG identifier of the first TAG is associated with a first TCI state that is indicated to be used for the first UL transmission by a DCI format that schedules the first UL transmission.

In some embodiments of the method 800, the first configuration for the first TAG identifies a CORESET pool associated with the first TAG, and the identifying that the first UL transmission is associated with the first TAG comprises determining that a DCI format that schedules the first UL transmission is received in a CORESET of the CORESET pool associated with the first TAG.

In some embodiments of the method 800, the first UL transmission is a grant-free UL transmission, and the identifying that the first UL transmission is associated with the first TAG comprises determining that a configuration at the UE for the grant-free UL transmission identifies a CORESET pool that is associated with the first TAG at the UE.

In some embodiments of the method 800, the first UL transmission is a grant-free UL transmission, and the identifying that the first UL transmission is associated with the first TAG comprises determining that a configuration for the grant-free UL transmission identifies a TAG identifier that is associated with the first TAG at the UE.

In some embodiments of the method 800, the identifying that the first UL transmission is associated with the first TAG comprises determining that a first TAG identifier identifying the first TAG is larger than a second TAG identifier identifying the second tag and determining that a PL RS of a TCI state configured at the UE that is used for the first UL transmission is one of an SSB of a non-serving cell of the UE and a CSI-RS with a first scrambling identifier that is different than a second scrambling identifier used by a PCI of a serving cell of the UE.

FIG. 9 illustrates a method 900 of a RAN, according to embodiments herein. The method 900 includes sending 902, to a UE, a TAG list comprising a plurality of configurations for a plurality of TAGs, the plurality of configurations comprising a first configuration for a first TAG useable in UL to communicate with a first TRP of the RAN using a frequency and a second configuration for a second TAG usable in UL to communicate with a second TRP of the network using the frequency.

The method 900 further includes receiving 904 a first UL transmission from the UE at the first TRP.

The method 900 further includes receiving 906 a second UL transmission from the UE at the second TRP.

In some embodiments of the method 900, the first configuration for the first TAG comprises a first time alignment timer for the first TAG. In some such embodiments, the second configuration for the second TAG comprises a second time alignment timer for the second TAG.

In some embodiments, the method 900 further includes sending, to the UE, an indication that a first HARQ buffer of the UE and a second HARQ buffer of the UE are shared across the first TAG and the second TAG.

In some embodiments, the method 900 further includes sending, to the UE, a first TCI state configuration that identifies the first TAG as associated with a first TCI state. In some such embodiments, the method 900 further includes sending, to the UE, a second TCI state configuration that identifies the second TAG as associated with a second TCI state.

In some embodiments of the method 900, the first configuration for the first TAG identifies a first CORESET pool that is associated with the first TAG. In some such embodiments, the second configuration for the second TAG identifies a second CORESET pool that is associated with the second TAG.

### DL Reference Timing Determinations for Two TAs for mTRP

Another issue that arises when using two TAs for UL mDCI mTRP relates to the DL reference timing(s) that serve as the basis to apply any received TA commands from the network to UL transmissions from the UE to corresponding TRPs. For example, the manner of determining the DL reference timing(s) for UL transmissions towards (each/either of) two TRPs may need to be defined.

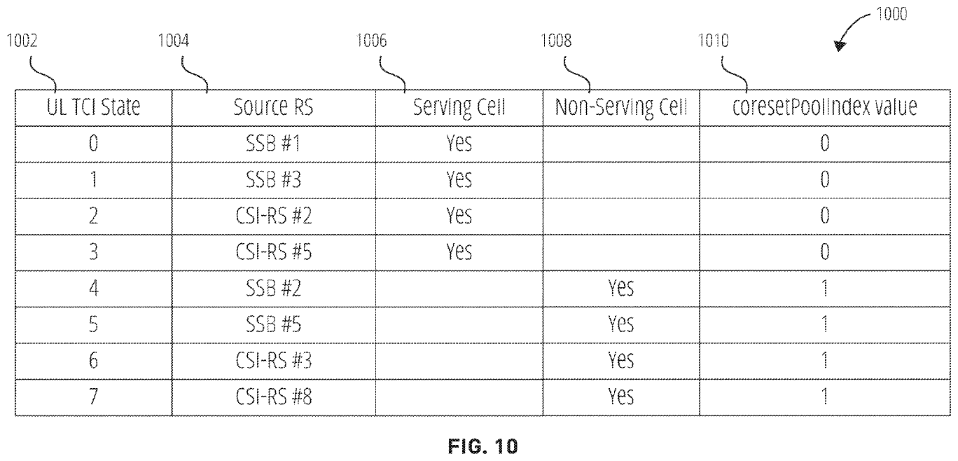

According to various aspects, a variety of alternatives maybe considered to determine a DL reference timing against which to apply the TA command for the UL transmission to the corresponding TRP. FIG. 10 illustrates a table 1000 showing information corresponding to various alternatives for determining DL reference timing for a TA command, according to embodiments herein. As seen in FIG. 10, it may be that, for example, a UE is configured with eight active TCI states 1002 for UL transmissions (which may be, e.g., joint UL/DL TCI state(s) and/or UL TCI state(s)) that have been activated at the UE using a medium access control control element (MAC-CE) TCI-state activation command.

In a first alternative, a DL reference timing against which the appropriate TA value is applied is determined based on a reception time of a source RS that is associated with a TCI state that is used by the UL transmission. Note that in a case where a source RS for a TCI state is a sounding reference signal (SRS), the pathloss RS associated with the TCI state may be used to determine the DL reference timing.

With reference to FIG. 10, it may be seen that each TCI state 1002 is associated with a different source RS. Accordingly, it may be understood that UE maintains eight timing loops corresponding to potential UL transmissions for each of the eight TCI states 1002, with each timing determined relative to the one of the source RSs 1004 that corresponds to that TCI state.

In a second alternative, the UE determines a first DL reference timing based on the first detected path (in time) of a corresponding DL frame from the group of source RSs of activated TCI states that are transmitted by a serving cell (e.g., a reception time of a first-in-time of the group of source RSs for the serving cell). Further, the UE determines a second DL reference timing based on the first detected path (in time) of a corresponding DL frame from the group of source RSs from the TCI states that are transmitted by a non-serving cell (e.g., a reception time of a first-in-time of the group of source RSs for the non-serving cell).

Accordingly, assuming the use of the TCI states 1002 of the table 1000, under the second alternative, the UE identifies that SSB #1, SSB #3, CSI-RS #2, and CSI-RS #5 (the source RSs of TCI states #0-3) are reference signals of a serving cell 1006, and that SSB #2, SSB #5, CSI-RS #3, and CSI-RS #8 (the source RSs of TCI states #4-7) are references signals of a non-serving cell 1008. A first DL reference timing is then determined/maintained based on the first-in-time to arrive (at the UE) of SSB #1, SSB #3, CSI-RS #2, and CSI-RS #5, and is used to apply a TA command that is associated with the TRP of the serving cell. Further, a second DL reference timing is determined/maintained based on the first-in-time to arrive (at the UE) of SSB #2, SSB #5, CSI-RS #3, and CSI-RS #8, and is used to apply a TA command that is associated with the TRP of the non-serving cell.

For relatively larger numbers of active TCI states at the UE, it may be that it is relatively complicated (from the perspective of UE implementation) to maintain a number of DL timings that is (up to) the number of active TCI states, as described in relation to the first alternative. This second alternative instead causes the UE to maintain DL reference timings on a per-cell basis, and therefore the upper limit on complexity as compared to the first alternative (where a number DL reference timings maintained is equal to (up to) the total number of active TCI states) may be lower for a same set of active TCI states at the UE.

In a third alternative, the UE determines a first DL reference timing based on the first detected path (in time) of a corresponding DL frame from the group of source RSs of activated TCI states associated with a first coresetPoolIndex values (e.g., a reception time of a first-in-time of the group of source RSs for activated TCI states associated with a first of the coresetPoolIndex values). Further, the UE determines a second DL reference timing based on the first detected path (in time) of the corresponding DL frame from the group of source RSs of activated TCI states associated with a second coresetPoolIndex value (e.g., a reception time of a first-in-time of the group of source RSs for activated TCI states associated with the other of the coresetPoolIndex values). In such cases, for each TCI state configured at the UE, a coresetPoolIndex value may be provided by RRC signaling. In some cases, the coresetPoolIndex values may be ‘0’ or ‘1’. In some cases, each of the TRPs may be associated with one or the other of the coresetPoolIndex by a TAG configuration for a TAG being used by the UE to communicate with that TRP that indicates the corresponding coresetPoolIndex value (as is described elsewhere herein).

Accordingly, assuming the use of the TCI states 1002 of the table 1000 and with further reference to the coresetPoolIndex values 1010 of the table 1000, under the third alternative, the UE identifies that the TCI states #0-3 are associated with a coresetPoolIndex value of ‘0’, and that SSB #1, SSB #3, CSI-RS #2, and CSI-RS #5 are the source RSs of TCI states #0-3. Further, the UE identifies that the TCI states #4-7 are associated with coresetPoolIndex value of ‘1’, and that SSB #2, SSB #5, CSI-RS #3, and CSI-RS #8 are the source RSs of TCI states #4-7. A first DL reference timing is then determined/maintained based on the first-in-time to arrive of SSB #1, SSB #3, CSI-RS #2, and CSI-RS #5, and is used to apply a TA command that is associated with the TRP corresponding to the coresetPoolIndex value of ‘0’. Further, a second DL reference timing is determined/maintained based on the first in time to arrive of SSB #2, SSB #5, CSI-RS #3, and CSI-RS #8, and is used to apply a TA command that is associated with the TRP corresponding to the coresetPoolIndex value of ‘1’.

Note that the particular arrangement of coresetPoolIndex value to TCI state illustrated in FIG. 7 is given by way of example and not by way of limitation. Other such arrangements are possible (including other such arrangements corresponding to the use of the same particular set of active TCI states illustrated in FIG. 7). It is also contemplated that in some alternative embodiments from that illustrated in FIG. 7, a different number (e.g., more than two) of coresetPoolIndex values may be assigned across one or more configured/activated TCI states at the UE, in which case a corresponding number of TAGs (e.g., more than two TAGs) may each be associated with one or more TCI states in the set.

This third alternative causes the UE to maintain DL reference timings on a per-coresetPoolIndex value basis, and therefore the upper limit on complexity as compared to the first alternative (where a number DL reference timings maintained is equal to (up to) the total number of active TCI states) may be lower for a same set of active TCI states at the UE. Further, because there is no assumption of the use of a serving cell and a non-serving cell the third alternative may be used in an intra-cell mTRP usage case.

In some embodiments (e.g., corresponding to the first through third alternatives), the UE may send a UE capability message to the network that indicates whether or not the UE supports a maximum DL reception timing difference between a first DL reference timing for the first TRP and a second DL reference timing for the second TRP that is larger than a cyclic prefix (CP) length used by the UE. In such a case where the different between the first DL reference timing and the second DL reference timing exceeds this CP length, it may be that the UE stops the use of one or both of the DL reference timings.

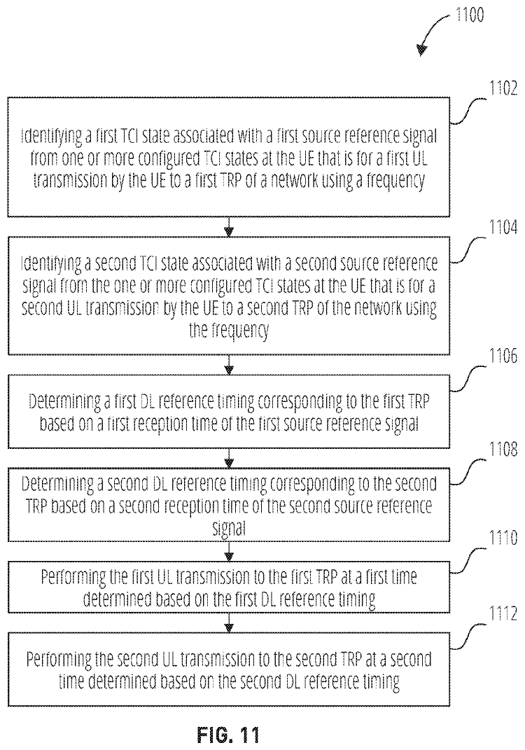

FIG. 11 illustrates a method 1100 of a UE, according to embodiments herein. The method 1100 includes identifying 1102 a first TCI state associated with a first source reference signal from one or more configured TCI states at the UE that is for a first UL transmission by the UE to a first TRP of a network using a frequency.

The method 1100 further includes identifying 1104 a second TCI state associated with a second source reference signal from the one or more configured TCI states at the UE that is for a second UL transmission by the UE to a second TRP of the network using the frequency.

The method 1100 further includes determining 1106 a first DL reference timing corresponding to the first TRP based on a first reception time of the first source reference signal.

The method 1100 further includes determining 1108 a second DL reference timing corresponding to the second TRP based on a second reception time of the second source reference signal.

The method 1100 further includes performing 1110 the first UL transmission to the first TRP at a first time determined based on the first DL reference timing.

The method 1100 further includes performing 1112 the second UL transmission to the second TRP at a second time determined based on the second DL reference timing.

In some embodiments, the method 1100 further includes sending, to the network, a UE capability message indicating whether the UE supports a use of a DL reception timing difference between the first DL reference timing and the second DL reference timing that is greater than a CP length used by the UE.

In some embodiments of the method 1100, the first UL transmission and the second UL transmission are on a same CC.

In some embodiments of the method 1100, the first UL transmission is on a first CC and the second UL transmission is on a second CC, wherein the first CC and the second CC are on the frequency.

In some embodiments of the method 1100, the first source reference signal comprises an SSB.

In some embodiments of the method 1100, the first source reference signal comprises a CSI-RS.

In some embodiments of the method 1100, the first source reference signal comprises a PL RS for the first TCI state.

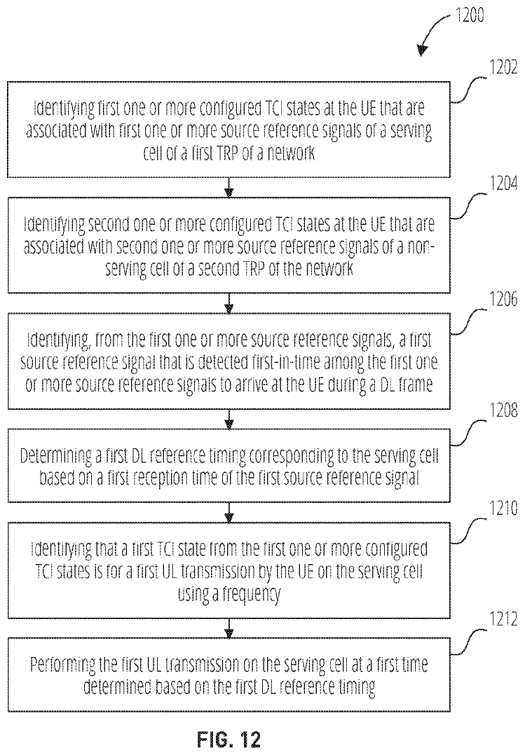

FIG. 12 illustrates a method 1200 of a UE, according to embodiments herein. The method 1200 includes identifying 1202 first one or more configured TCI states at the UE that are associated with first one or more source reference signals of a serving cell of a first TRP of a network.

The method 1200 further includes identifying 1204 second one or more configured TCI states at the UE that are associated with second one or more source reference signals of a non-serving cell of a second TRP of the network.

The method 1200 further includes identifying 1206 from the first one or more source reference signals, a first source reference signal that is detected first-in-time among the first one or more source reference signals to arrive at the UE during a DL frame.

The method 1200 further includes determining 1208 a first DL reference timing corresponding to the serving cell based on a first reception time of the first source reference signal.

The method 1200 further includes identifying 1210 that a first TCI state from the first one or more configured TCI states is for a first UL transmission by the UE on the serving cell using a frequency.

The method 1200 further includes performing 1212 the first UL transmission on the serving cell at a first time determined based on the first DL reference timing.

In some embodiments, the method 1200 further includes identifying, from the second one or more source reference signals, a second source reference signal that is detected first-in-time among the second one or more source reference signals to arrive at the UE during the DL frame, determining a second DL reference timing corresponding to the non-serving cell based on a second reception time of the second source reference signal, identifying that a second TCI state from the second one or more configured TCI states is for a second UL transmission by the UE on the non-serving cell using the frequency, and performing the second UL transmission on the non-serving cell at a second time determined based on the second DL reference timing.

In some embodiments, the method 1200 further includes sending, to the network, a UE capability message indicating whether the UE supports a use of a DL reception timing difference between the first DL reference timing and a second DL reference timing corresponding to the non-serving cell of the second TRP that is greater than a CP length used by the UE.

In some embodiments of the method 1200, the first one or more source reference signals comprises an SSB.

In some embodiments of the method 1200, the first one or more source reference signals comprises a CSI-RS.

In some embodiments of the method 1200, the first one or more source reference signals comprises a PL RS for one of the first one or more configured TCI states.

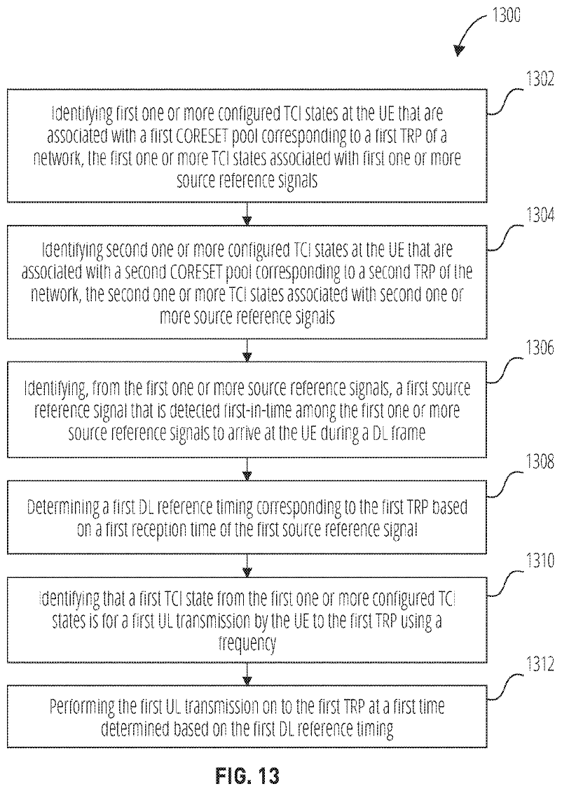

FIG. 13 illustrates a method 1300 of a UE, according to embodiments herein. The method 1300 includes identifying 1302 first one or more configured TCI states at the UE that are associated with a first CORESET pool corresponding to a first TRP of a network, the first one or more TCI states associated with first one or more source reference signals.

The method 1300 further includes identifying 1304 second one or more configured TCI states at the UE that are associated with a second CORESET pool corresponding to a second TRP of the network, the second one or more TCI states associated with second one or more source reference signals.

The method 1300 further includes identifying 1306, from the first one or more source reference signals, a first source reference signal that is detected first-in-time among the first one or more source reference signals to arrive at the UE during a DL frame.

The method 1300 further includes determining 1308 a first DL reference timing corresponding to the first TRP based on a first reception time of the first source reference signal.

The method 1300 further includes identifying 1310 that a first TCI state from the first one or more configured TCI states is for a first UL transmission by the UE to the first TRP using a frequency.

The method 1300 further includes performing 1312 the first UL transmission on to the first TRP at a first time determined based on the first DL reference timing.

In some embodiments, the method 1300 further includes identifying, from the second one or more source reference signals, a second source reference signal that is detected first-in-time among the second one or more source reference signals to arrive at the UE during the DL frame, determining a second DL reference timing corresponding to the second TRP based on a second reception time of the second source reference signal, identifying that a second TCI state from the second one or more configured TCI states is for a second UL transmission by the UE to the second TRP using the frequency, and performing the second UL transmission to the second TRP at a second time determined based on the second DL reference timing.

In some embodiments of the method 1300, the first UL transmission and the second UL transmission are on a same CC.

In some embodiments of the method 1300, the first UL transmission is on a first CC and the second UL transmission is on a second CC, wherein the first CC and the second CC are on the frequency.

In some embodiments, the method 1300 further includes sending, to the network, a UE capability message indicating whether the UE supports a use of a DL reception timing difference between the first DL reference timing and a second DL reference timing corresponding to the second serving cell of the second TRP that is greater than a CP length used by the UE.

In some embodiments of the method 1300, the first one or more source reference signals comprises an SSB.

In some embodiments of the method 1300, the first one or more source reference signals comprises a CSI-RS.

In some embodiments of the method 1300, the first one or more source reference signals comprises a PL RS for one of the first one or more configured TCI states.

### Overlapped UL Transmissions with Two TAs

Another issue that arises when using two TAs for UL mDCI mTRP relates to the handling of overlapping that may occur between UL transmissions in two adjacent slots towards different TRPs using different TAs. This consideration may be applicable in, for example, cases where the wireless communications system includes one or more UEs that are not capable of simultaneous UL transmission across a pair of UL antenna panels.

In such cases, the exact overlapped length depends on the PUSCH time domain resource assignment (TDRA) value and an N_{TA,offset} configuration. If a single N_{TA,offset} is configured and shared for two TRPs, the maximum overlapping length for 15 kilohertz (kHz) subcarrier spacing (SCS) can be 32·16·64·T_{c}=32768*T_{c}≈16 us, which is, larger than a CP length and ⅕ of an orthogonal frequency division multiplexing (OFDM) symbol. However, if separate N_{TA,offset} values are configured for two TRPs, the maximum overlapping length for two consecutive slots can be (39936+63)·16·64*T_{c}, which may be up to several OFDM symbols.

Note that in cases using different TAs for different TRPs, the overlapping of two slots for two panels in the described manner can occur regularly, due to the fact that independent schedulers may be used for two TRPs and the fact that a BH may be non-ideal (e.g., BH characteristics applicable to the first TAG are not the same as BH characteristics applicable to the second TAG). Accordingly, a defined manner of handling such overlapped UL transmissions within the system promotes system performance with respect to this relatively common scenario.

A variety of approaches maybe considered to handle cases where such an overlap between two UL transmissions associated with two TAs exists.

Under a first alternative, it may be that a use of one or other of the slots as adjusted by the corresponding TA for the corresponding TRP is reduced in duration for that TRP relative to the normal slot to account for the overlap. In other words, data of a UL transmission on the UL panel corresponding to the TRP for the overlapped portion of the slot for the UL transmission (as adjusted by the corresponding TA) is dropped at the UE.

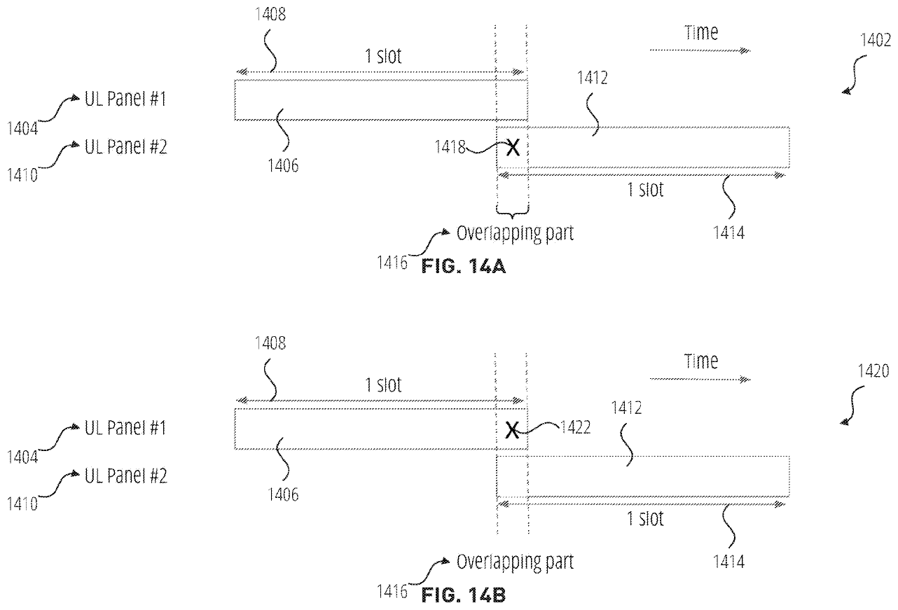

FIG. 14A illustrates a diagram 1402 showing a manner of dropping data of a UL transmission in the case of an overlap between slots for two UL transmissions at different UL panels of the UE, according to embodiments herein. As illustrated, a UE includes a first UL panel 1404 which is being used to perform a first UL transmission 1406 on a first slot 1408 and a second UL panel 1410 that is being used to perform a second UL transmission 1412 on a second slot 1414. In the case that the first UL panel 1404 and the first UL transmission 1406 are for different TRPs, different TAs may apply corresponding to the first UL transmission 1406 on the first UL panel 1404 and the second UL transmission 1412 on the second UL panel 1410. Accordingly, an overlap 1416 between the ending portion of the first slot 1408 used by first UL transmission 1406 on the first UL panel 1404 (as adjusted by the applicable TA value for the first UL transmission 1406) and the beginning portion second slot 1414 for the second UL transmission 1412 on the second UL panel 1410 (as adjusted the applicable TA value for the second UL transmission 1412) exists, causing the first UL transmission 1406 and the second UL transmission 1412 to collide.

As illustrated, in the case of FIG. 14A, to resolve the collision, the UE drops 1418 data of the second UL transmission 1412 that is that is for the beginning portion of the second slot 1414 that overlaps with the first slot 1408.

FIG. 14B illustrates a diagram 1420 showing a manner of dropping data of a UL transmission in the case of an overlap between slots for two UL transmissions at different UL panels of the UE, according to embodiments herein. The first UL panel 1404, the first UL transmission 1406, the first slot 1408, the second UL panel 1410, the second UL transmission 1412, the second slot 1414, and the overlap 1416 may all be arranged as was described in relation to FIG. 14A.

However, as illustrated, differently from the case of FIG. 14A, in the case of FIG. 14B, to resolve the collision, the UE drops 1422 data of the first UL transmission 1406 that is for the ending portion of the first slot 1408 that overlaps with the second slot 1414.

Note that in some cases, dropping a portion of overlapped data from the earlier slot (as in FIG. 14B) is more preferable than dropping a portion overlapped data from a later slot (as in FIG. 14A), because this causes data at the end of a slot (e.g., at the end of the first slot 1408, as in FIG. 14B) to be dropped as opposed to the dropping of data at the beginning of a slot (e.g., at the beginning of the second slot 1414, as in FIG. 14A). This option may be used to preserve demodulation reference signal (DMRS) and/or uplink control information (UCI) symbols which may be found at the beginning of a UL transmission in the slot (such as may be found at the beginning of the second UL transmission 1412 in the second slot 1414).

In some cases, if the UE supports simultaneous transmissions over multiple panels (STxMP) (and, e.g., indicates the same through a UE capability report), it may be that both slots (e.g., the first slot 1408 and the second slot 1414) are used without a corresponding data reduction (even in the case where there is an overlap).

In some cases, a UL transmission associated with a serving cell maybe prioritized over the overlapped UL transmission of a non-serving cell. In such cases, corresponding to FIG. 14A and FIG. 14B, this may mean, for example, that the one of the first UL transmission 1406 and the second UL transmission 1412 that has its data dropped 1418/1422 depends on which of these is for a serving cell of the UE (not dropped) and which of these is for a non-serving cell (dropped). This may promote a reliability of the UE to network connection.

Under another alternative, signaling between the UE and the network may determine how to handle first and second UL transmissions in cases where the ending portion of a first slot for the first UL transmission on a first second UL panel 1410 overlaps a beginning portion of a second slot for the second transmission on a second UL panel, as has been described. This value may correspond to the difference between an end of the first slot and the beginning of the second slot. The UE measures the UL timing difference between the two applicable intra frequency TAGs for the two TRPs, and then reports this value to the network. This value may be measured/reported in units of OFDM symbols (e.g., the UE may report a number of symbols N to the network, where N≥1).

In some such cases, based on the reported UL timing difference N, the network (e.g., a base station of the network) may provide the UE with a collision handling indication that indicates the manner of handling the overlapped UL transmissions.

In a first example, the collision handling indication sent by the network to the UE indicates that N beginning symbols of the second slot should not be used on the second UL panel. Accordingly, the UE drops data of the second UL transmission that is for the N beginning symbols of the second slot.

In a second example, the collision handling indication sent by the network to the UE indicates that N ending symbols of the first slot should not be used on the first UL panel.

Accordingly, the UE drops data of the first UL transmission that is for the N ending symbols of the first slot.

In a third example, the collision handling indication sent by the network to the UE indicates that a first number K₁ of ending symbols of the first slot should not be used on the first UL panel and that a second number K₂ of beginning symbols of the second slot should not be used on the second UL panel. In such cases, it may be that K₁+K₂=N, with K₁≥0 and K₂≥0. Accordingly, the UE drops data of the first UL transmission that is for the K₁ ending symbols of the first slot and also drops data of the second UL transmission that is for the K₂ beginning symbols of the second slot.

In some cases, it may be that once the UE provides the network with the reported UL timing difference N, the UE is not expected by the network to transmit the UL symbols within the overlapped N symbols on either of the first slot for the first UL panel or the second slot for the second UL panel. In these cases, the transmission of the reported UL timing difference N accordingly put an effective restriction on the network/base station scheduler to avoid scheduling and/or not to otherwise expect UL communications from the UE during such symbols.

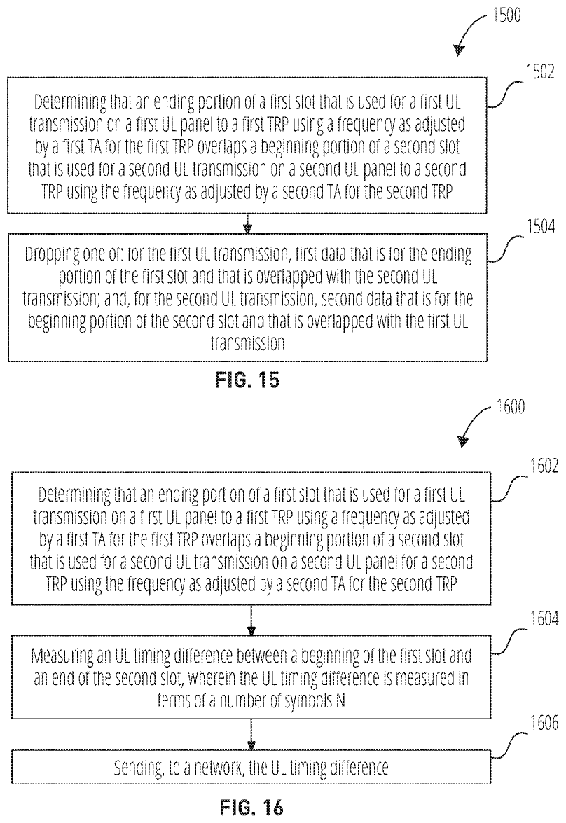

FIG. 15 illustrates a method 1500 of a UE, according to embodiments herein. The method 1500 includes determining 1502 that an ending portion of a first slot that is used for a first UL transmission on a first UL panel to a first TRP using a frequency as adjusted by a first TA for the first TRP overlaps a beginning portion of a second slot that is used for a second UL transmission on a second UL panel to a second TRP using the frequency as adjusted by a second TA for the second TRP.

The method 1500 further includes dropping 1504 one of: for the first UL transmission, first data that is for the ending portion of the first slot and that is overlapped with the second UL transmission; and, for the second UL transmission, second data that is for the beginning portion of the second slot and that is overlapped with the first UL transmission.

In some embodiments of the method 1500, the UE is not capable of STxMP function.

In some embodiments, the method 1500 further includes determining that the first UL transmission is for a serving cell and that the second UL transmission is for a non-serving cell, wherein the second data of the second UL transmission is dropped in response to the determination that the first UL transmission is for the serving cell and that the second UL transmission is for the non-serving cell.

FIG. 16 illustrates a method 1600 of a UE, according to embodiments herein. The method 1600 includes determining 1602 that an ending portion of a first slot that is used for a first UL transmission on a first UL panel to a first TRP using a frequency as adjusted by a first TA for the first TRP overlaps a beginning portion of a second slot that is used for a second UL transmission on a second UL panel for a second TRP using the frequency as adjusted by a second TA for the second TRP.

The method 1600 further includes measuring 1604 an UL timing difference between a beginning of the first slot and an end of the second slot, wherein the UL timing difference is measured in terms of a number of symbols N.

The method 1600 further includes sending 1606, to a network, the UL timing difference.

In some embodiments, the method 1600 further includes receiving, from the network, a collision handling indication indicating that N beginning symbols of the second slot should not be used on the second UL panel and dropping data of the second UL transmission that is for the N beginning symbols of the second slot.

In some embodiments, the method 1600 further includes receiving, from the network, a collision handling indication indicating that W ending symbols of the first slot should not be used on the first UL panel and dropping data of the first UL transmission that is for the N ending symbols of the first slot.

In some embodiments, the method 1600 further includes receiving, from the network, a collision handling indication indicating that a first number K₁ of ending symbols of the first slot should not be used on the first UL panel and a second number K₂ of beginning symbols of the second slot should not be used on the second UL panel, wherein K₁ plus K₂ is equal to N, dropping first data of the first UL transmission that is for the K₁ ending symbols of the first slot, and dropping second data of the second UL transmission that is for the K₂ beginning symbols of the second slot.

In some embodiments, the method 1600 further includes dropping first data of the first UL transmission that is for N ending symbols of the first slot, and dropping second data of the second UL transmission that is for N beginning symbols of the second slot.

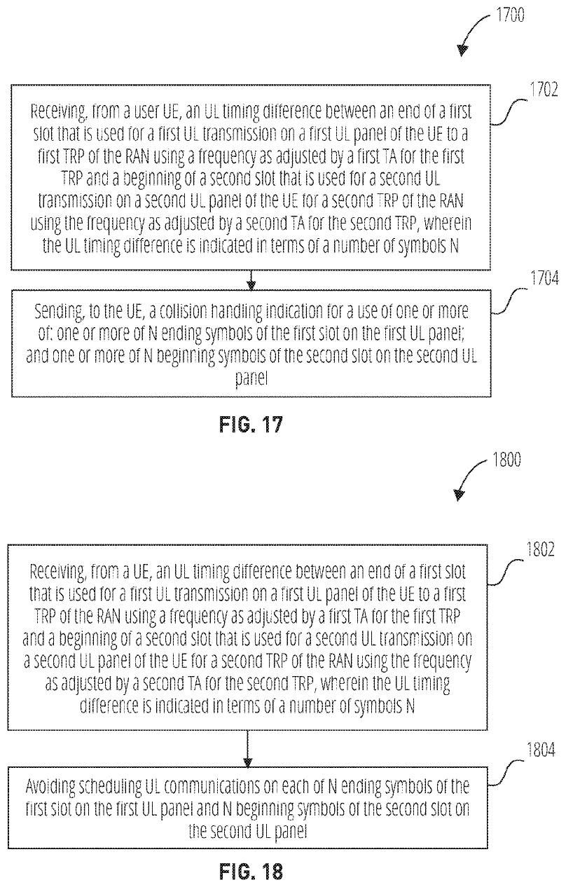

FIG. 17 illustrates a method 1700 of a RAN, according to embodiments herein. The method 1700 includes receiving 1702, from a UE, an UL timing difference between an end of a first slot that is used for a first UL transmission on a first UL panel of the UE to a first TRP of the RAN using a frequency as adjusted by a first TA for the first TRP and a beginning of a second slot that is used for a second UL transmission on a second UL panel of the UE for a second TRP of the RAN using the frequency as adjusted by a second TA for the second TRP, wherein the UL timing difference is indicated in terms of a number of symbols N.

The method 1700 further includes sending 1704, to the UE, a collision handling indication for a use of one or more of: one or more of N ending symbols of the first slot on the first UL panel; and one or more of N beginning symbols of the second slot on the second UL panel.

In some embodiments of the method 1700, the collision handling indication indicates to the UE not to use the N ending symbols of the first slot on the first UL panel.

In some embodiments of the method 1700, the collision handling indication indicates to the UE not to use the N beginning symbols of the second slot on the second UL panel.

In some embodiments of the method 1700, the collision handling indication indicates to the UE not to use a first number K₁ of ending symbols of the first slot on the first UL panel and not to use a second number K₂ of beginning symbols of the second slot on the second UL panel, wherein K₁ plus K₂ is equal to N.

FIG. 18 illustrates a method 1800 of a RAN, according to embodiments herein. The method 1800 includes receiving 1802, from a UE, an UL timing difference between an end of a first slot that is used for a first UL transmission on a first UL panel of the UE to a first TRP of the RAN using a frequency as adjusted by a first TA for the first TRP and a beginning of a second slot that is used for a second UL transmission on a second UL panel of the UE for a second TRP of the RAN using the frequency as adjusted by a second TA for the second TRP, wherein the UL timing difference is indicated in terms of a number of symbols N.

The method 1800 further includes avoiding 1804 scheduling UL communications on each of N ending symbols of the first slot on the first UL panel and N beginning symbols of the second slot on the second UL panel.

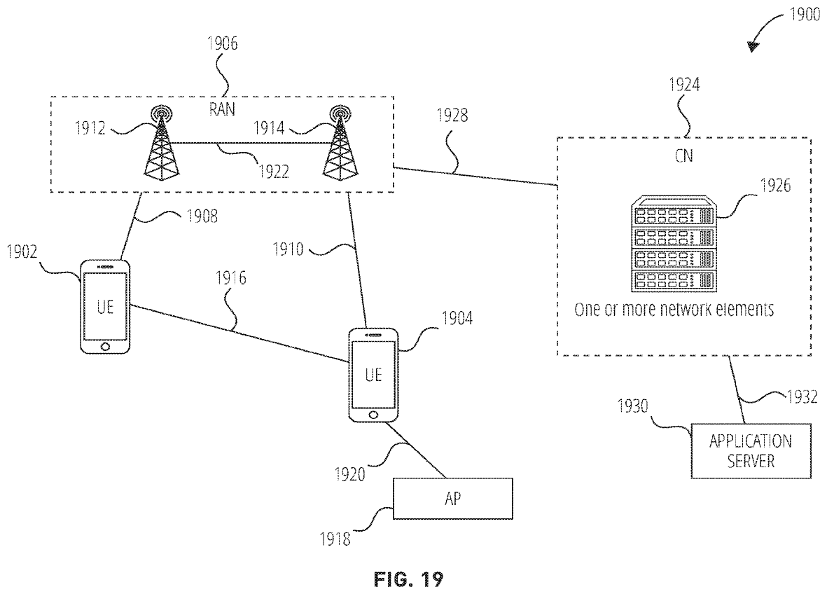

FIG. 19 illustrates an example architecture of a wireless communication system 1900, according to embodiments disclosed herein. The following description is provided for an example wireless communication system 1900 that operates in conjunction with the LTE system standards and/or 5G or NR system standards as provided by 3GPP technical specifications.

As shown by FIG. 19, the wireless communication system 1900 includes UE 1902 and UE 1904 (although any number of UEs may be used). In this example, the UE 1902 and the UE 1904 are illustrated as smartphones (e.g., handheld touchscreen mobile computing devices connectable to one or more cellular networks), but may also comprise any mobile or non-mobile computing device configured for wireless communication.

The UE 1902 and UE 1904 may be configured to communicatively couple with a RAN 1906. In embodiments, the RAN 1906 may be NG-RAN, E-UTRAN, etc. The UE 1902 and UE 1904 utilize connections (or channels) (shown as connection 1908 and connection 1910, respectively) with the RAN 1906, each of which comprises a physical communications interface. The RAN 1906 can include one or more base stations (such as base station 1912 and base station 1914) that enable the connection 1908 and connection 1910.

In this example, the connection 1908 and connection 1910 are air interfaces to enable such communicative coupling, and may be consistent with RAT(s) used by the RAN 1906, such as, for example, an LTE and/or NR.

In some embodiments, the UE 1902 and UE 1904 may also directly exchange communication data via a sidelink interface 1916. The UE 1904 is shown to be configured to access an access point (shown as AP 1918) via connection 1920. By way of example, the connection 1920 can comprise a local wireless connection, such as a connection consistent with any IEEE 802.11 protocol, wherein the AP 1918 may comprise a Wi-Fi router. In this example, the AP 1918 may be connected to another network (for example, the Internet) without going through a CN 1924.

In embodiments, the UE 1902 and UE 1904 can be configured to communicate using orthogonal frequency division multiplexing (OFDM) communication signals with each other or with the base station 1912 and/or the base station 1914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1912 or base station 1914 may be implemented as one or more software entities running on server computers as part of a virtual network. In addition, or in other embodiments, the base station 1912 or base station 1914 may be configured to communicate with one another via interface 1922. In embodiments where the wireless communication system 1900 is an LTE system (e.g., when the CN 1924 is an EPC), the interface 1922 may be an X2 interface. The X2 interface may be defined between two or more base stations (e.g., two or more eNBs and the like) that connect to an EPC, and/or between two eNBs connecting to the EPC. In embodiments where the wireless communication system 1900 is an NR system (e.g., when CN 1924 is a 5GC), the interface 1922 may be an Xn interface. The Xn interface is defined between two or more base stations (e.g., two or more gNBs and the like) that connect to 5GC, between a base station 1912 (e.g., a gNB) connecting to 5GC and an eNB, and/or between two eNBs connecting to 5GC (e.g., CN 1924).

The RAN 1906 is shown to be communicatively coupled to the CN 1924. The CN 1924 may comprise one or more network elements 1926, which are configured to offer various data and telecommunications services to customers/subscribers (e.g., users of UE 1902 and UE 1904) who are connected to the CN 1924 via the RAN 1906. The components of the CN 1924 may be implemented in one physical device or separate physical devices including components to read and execute instructions from a machine-readable or computer-readable medium (e.g., a non-transitory machine-readable storage medium).

In embodiments, the CN 1924 may be an EPC, and the RAN 1906 may be connected with the CN 1924 via an S1 interface 1928. In embodiments, the S1 interface 1928 may be split into two parts, an S1 user plane (S1-U) interface, which carries traffic data between the base station 1912 or base station 1914 and a serving gateway (S-GW), and the S1-MME interface, which is a signaling interface between the base station 1912 or base station 1914 and mobility management entities (MMEs).

In embodiments, the CN 1924 may be a SGC, and the RAN 1906 may be connected with the CN 1924 via an NG interface 1928. In embodiments, the NG interface 1928 may be split into two parts, an NG user plane (NG-U) interface, which carries traffic data between the base station 1912 or base station 1914 and a user plane function (UPF), and the SI control plane (NG-C) interface, which is a signaling interface between the base station 1912 or base station 1914 and access and mobility management functions (AMFs).

Generally, an application server 1930 may be an element offering applications that use internet protocol (IP) bearer resources with the CN 1924 (e.g., packet switched data services). The application server 1930 can also be configured to support one or more communication services (e.g., VoIP sessions, group communication sessions, etc.) for the UE 1902 and UE 1904 via the CN 1924. The application server 1930 may communicate with the CN 1924 through an IP communications interface 1932.

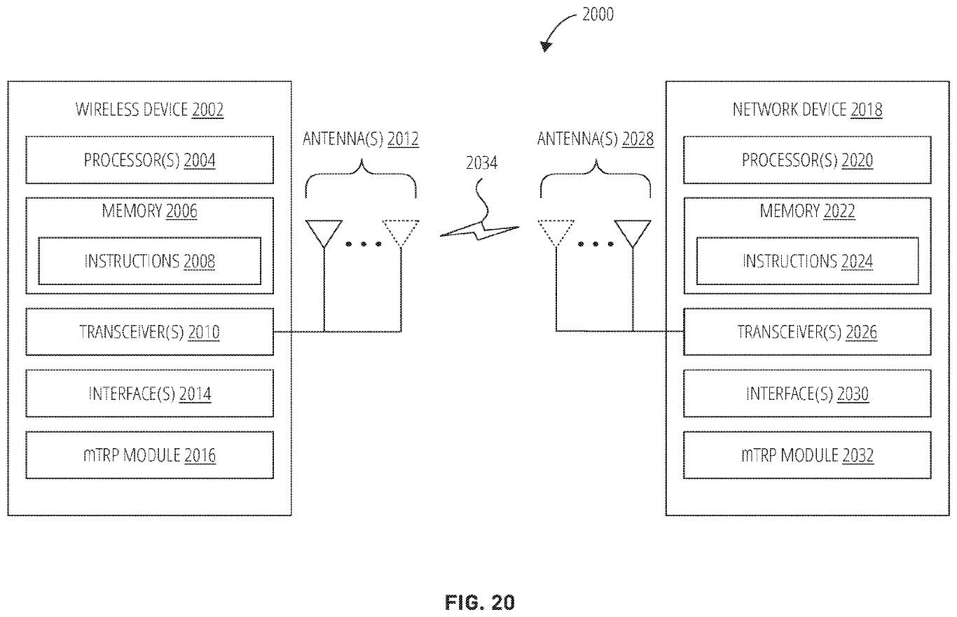

FIG. 20 illustrates a system 2000 for performing signaling 2034 between a wireless device 2002 and a network device 2018, according to embodiments disclosed herein. The system 2000 may be a portion of a wireless communications system as herein described. The wireless device 2002 may be, for example, a UE of a wireless communication system. The network device 2018 may be, for example, a base station (e.g., an eNB or a gNB) of a wireless communication system.

The wireless device 2002 may include one or more processor(s) 2004. The processor(s) 2004 may execute instructions such that various operations of the wireless device 2002 are performed, as described herein. The processor(s) 2004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2002 may include a memory 2006. The memory 2006 may be a non-transitory computer-readable storage medium that stores instructions 2008 (which may include, for example, the instructions being executed by the processor(s) 2004). The instructions 2008 may also be referred to as program code or a computer program. The memory 2006 may also store data used by, and results computed by, the processor(s) 2004.

The wireless device 2002 may include one or more transceiver(s) 2010 that may include radio frequency (RF) transmitter and/or receiver circuitry that use the antenna(s) 2012 of the wireless device 2002 to facilitate signaling (e.g., the signaling 2034) to and/or from the wireless device 2002 with other devices (e.g., the network device 2018) according to corresponding RATs.

The wireless device 2002 may include one or more antenna(s) 2012 (e.g., one, two, four, or more). For embodiments with multiple antenna(s) 2012, the wireless device 2002 may leverage the spatial diversity of such multiple antenna(s) 2012 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 2002 may be accomplished according to precoding (or digital beamforming) that is applied at the wireless device 2002 that multiplexes the data streams across the antenna(s) 2012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2002 may implement analog beamforming techniques, whereby phases of the signals sent by the antenna(s) 2012 are relatively adjusted such that the (joint) transmission of the antenna(s) 2012 can be directed (this is sometimes referred to as beam steering).

The wireless device 2002 may include one or more interface(s) 2014. The interface(s) 2014 may be used to provide input to or output from the wireless device 2002. For example, a wireless device 2002 that is a UE may include interface(s) 2014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 2010/antenna(s) 2012 already described) that allow for communication between the UE and other devices and may operate according to known protocols (e.g., Wi-Fi®, Bluetooth®, and the like).

The wireless device 2002 may include a mTRP module 2016. The mTRP module 2016 may be implemented via hardware, software, or combinations thereof. For example, the mTRP module 2016 may be implemented as a processor, circuit, and/or instructions 2008 stored in the memory 2006 and executed by the processor(s) 2004. In some examples, the mTRP module 2016 may be integrated within the processor(s) 2004 and/or the transceiver(s) 2010. For example, the mTRP module 2016 may be implemented by a combination of software components (e.g., executed by a DSP or a general processor) and hardware components (e.g., logic gates and circuitry) within the processor(s) 2004 or the transceiver(s) 2010.

The mTRP module 2016 may be used for various aspects of the present disclosure, for example, aspects corresponding to FIG. 1 through FIG. 18. The mTRP module 2016 may be configured to, for example, perform TAG association for different UL transmissions for mDCI mTRP, perform DL reference timing determinations for two TAs for mTRP, and/or handle overlapped UL transmissions with two TAs, as is described herein.

The network device 2018 may include one or more processor(s) 2020. The processor(s) 2020 may execute instructions such that various operations of the network device 2018 are performed, as described herein. The processor(s) 2020 may include one or more baseband processors implemented using, for example, a CPU, a DSP, an ASIC, a controller, an FPGA device, another hardware device, a firmware device, or any combination thereof configured to perform the operations described herein.

The network device 2018 may include a memory 2022. The memory 2022 may be a non-transitory computer-readable storage medium that stores instructions 2024 (which may include, for example, the instructions being executed by the processor(s) 2020). The instructions 2024 may also be referred to as program code or a computer program. The memory 2022 may also store data used by, and results computed by, the processor(s) 2020.

The network device 2018 may include one or more transceiver(s) 2026 that may include RF transmitter and/or receiver circuitry that use the antenna(s) 2028 of the network device 2018 to facilitate signaling (e.g., the signaling 2034) to and/or from the network device 2018 with other devices (e.g., the wireless device 2002) according to corresponding RATs.

The network device 2018 may include one or more antenna(s) 2028 (e.g., one, two, four, or more). In embodiments having multiple antenna(s) 2028, the network device 2018 may perform MIMO, digital beamforming, analog beamforming, beam steering, etc., as has been described.

The network device 2018 may include one or more interface(s) 2030. The interface(s) 2030 may be used to provide input to or output from the network device 2018. For example, a network device 2018 that is a base station may include interface(s) 2030 made up of transmitters, receivers, and other circuitry (e.g., other than the transceiver(s) 2026/antenna(s) 2028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2018 may include a mTRP module 2032. The mTRP module 2032 may be implemented via hardware, software, or combinations thereof. For example, the mTRP module 2032 may be implemented as a processor, circuit, and/or instructions 2024 stored in the memory 2022 and executed by the processor(s) 2020. In some examples, the mTRP module 2032 may be integrated within the processor(s) 2020 and/or the transceiver(s) 2026. For example, the mTRP module 2032 may be implemented by a combination of software components (e.g., executed by a DSP or a general processor) and hardware components (e.g., logic gates and circuitry) within the processor(s) 2020 or the transceiver(s) 2026.

The mTRP module 2032 may be used for various aspects of the present disclosure, for example, aspects corresponding to FIG. 1 through FIG. 18. The mTRP module 2032 may be configured to, for example, perform network aspects for TAG association for different UL transmissions for mDCI mTRP and/or perform network aspects related to handling overlapped UL transmissions with two TAs, as is described herein.

Embodiments contemplated herein include an apparatus comprising means to perform one or more elements of any of the method 800, the method 1100, the method 1200, the method 1300, the method 1500, and/or the method 1600. This apparatus may be, for example, an apparatus of a UE (such as a wireless device 2002 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 800, the method 1100, the method 1200, the method 1300, the method 1500, and/or the method 1600. This non-transitory computer-readable media may be, for example, a memory of a UE (such as a memory 2006 of a wireless device 2002 that is a UE, as described herein).

Embodiments contemplated herein include an apparatus comprising logic, modules, or circuitry to perform one or more elements of any of the method 800, the method 1100, the method 1200, the method 1300, the method 1500, and/or the method 1600. This apparatus may be, for example, an apparatus of a UE (such as a wireless device 2002 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 800, the method 1100, the method 1200, the method 1300, the method 1500, and/or the method 1600. This apparatus may be, for example, an apparatus of a UE (such as a wireless device 2002 that is a UE, as described herein).

Embodiments contemplated herein include a signal as described in or related to one or more elements of any of the method 800, the method 1100, the method 1200, the method 1300, the method 1500, and/or the method 1600.

Embodiments contemplated herein include a computer program or computer program product comprising instructions, wherein execution of the program by a processor is to cause the processor to carry out one or more elements of any of the method 800, the method 1100, the method 1200, the method 1300, the method 1500, and/or the method 1600. The processor may be a processor of a UE (such as a processor(s) 2004 of a wireless device 2002 that is a UE, as described herein). These instructions may be, for example, located in the processor and/or on a memory of the UE (such as a memory 2006 of a wireless device 2002 that is a UE, as described herein).

Embodiments contemplated herein include an apparatus comprising means to perform one or more elements of any of the method 900, the method 1700, and/or the method 1800. This apparatus may be, for example, an apparatus of a base station of a RAN (such as a network device 2018 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 900, the method 1700, and/or the method 1800. This non-transitory computer-readable media may be, for example, a memory of a base station of a RAN (such as a memory 2022 of a network device 2018 that is a base station, as described herein).

Embodiments contemplated herein include an apparatus comprising logic, modules, or circuitry to perform one or more elements of any of the method 900, the method 1700, and/or the method 1800. This apparatus may be, for example, an apparatus of a base station of a RAN (such as a network device 2018 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 900, the method 1700, and/or the method 1800. This apparatus may be, for example, an apparatus of a base station of a RAN (such as a network device 2018 that is a base station, as described herein).

Embodiments contemplated herein include a signal as described in or related to one or more elements of any of the method 900, the method 1700, and/or the method 1800.

Embodiments contemplated herein include a computer program or computer program product comprising instructions, wherein execution of the program by a processing element is to cause the processing element to carry out one or more elements of any of the method 900, the method 1700, and/or the method 1800. The processor may be a processor of a base station of a RAN (such as a processor(s) 2020 of a network device 2018 that is a base station, as described herein). These instructions may be, for example, located in the processor and/or on a memory of the base station of a RAN (such as a memory 2022 of a network device 2018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
determining that an ending portion of a first slot that is used for a first uplink (UL) transmission on a first UL panel to a first transmission reception point (TRP) using a frequency as adjusted by a first timing advance (TA) for the first TRP overlaps a beginning portion of a second slot that is used for a second UL transmission on a second UL panel to a second TRP using the frequency as adjusted by a second TA for the second TRP;
dropping one of:
for the first UL transmission, first data that is for the ending portion of the first slot and that is overlapped with the second UL transmission; and
for the second UL transmission, second data that is for the beginning portion of the second slot and that is overlapped with the first UL transmission.

2. The method of claim 1, wherein the UE is not capable of simultaneous uplink transmissions over multiple panels (STxMP) function.

3. The method of claim 1, further comprising:
determining that the first UL transmission is for a serving cell and that the second UL transmission is for a non-serving cell;
wherein the second data of the second UL transmission is dropped in response to the determination that the first UL transmission is for the serving cell and that the second UL transmission is for the non-serving cell.

4. A method of a user equipment (UE), comprising:
determining that an ending portion of a first slot that is used for a first uplink (UL) transmission on a first UL panel to a first transmission reception point (TRP) using a frequency as adjusted by a first timing advance (TA) for the first TRP overlaps a beginning portion of a second slot that is used for a second UL transmission on a second UL panel for a second TRP using the frequency as adjusted by a second TA for the second TRP;
measuring an UL timing difference between a beginning of the first slot and an end of the second slot, wherein the UL timing difference is measured in terms of a number of symbols N; and
sending, to a network, the UL timing difference.

5. The method of claim 4, further comprising:
receiving, from the network, a collision handling indication indicating that N beginning symbols of the second slot should not be used on the second UL panel; and
dropping data of the second UL transmission that is for the N beginning symbols of the second slot.

6. The method of claim 4, further comprising:
receiving, from the network, a collision handling indication indicating that N ending symbols of the first slot should not be used on the first UL panel; and
dropping data of the first UL transmission that is for the N ending symbols of the first slot.

7. The method of claim 4, further comprising:
receiving, from the network, a collision handling indication indicating that a first number K₁ of ending symbols of the first slot should not be used on the first UL panel and a second number K₂ of beginning symbols of the second slot should not be used on the second UL panel, wherein K₁ plus K₂ is equal to N;
dropping first data of the first UL transmission that is for the K₁ ending symbols of the first slot; and
dropping second data of the second UL transmission that is for the K₂ beginning symbols of the second slot.

8. The method of claim 4, further comprising:
dropping first data of the first UL transmission that is for N ending symbols of the first slot; and
dropping second data of the second UL transmission that is for N beginning symbols of the second slot.

9. A method of a radio access network (RAN), comprising:
receiving, from a user equipment (UE), an uplink (UL) timing difference between an end of a first slot that is used for a first UL transmission on a first UL panel of the UE to a first transmission reception point (TRP) of the RAN using a frequency as adjusted by a first timing advance (TA) for the first TRP and a beginning of a second slot that is used for a second UL transmission on a second UL panel of the UE for a second TRP of the RAN using the frequency as adjusted by a second TA for the second TRP, wherein the UL timing difference is indicated in terms of a number of symbols N; and
sending, to the UE, a collision handling indication for a use of one or more of:
one or more of N ending symbols of the first slot on the first UL panel; and
one or more of N beginning symbols of the second slot on the second UL panel.

10. The method of claim 9, wherein the collision handling indication indicates to the UE not to use the N ending symbols of the first slot on the first UL panel.

11. The method of claim 9, wherein the collision handling indication indicates to the UE not to use the N beginning symbols of the second slot on the second UL panel.

12. The method of claim 9, wherein the collision handling indication indicates to the UE not to use a first number K₁ of ending symbols of the first slot on the first UL panel and not to use a second number K₂ of beginning symbols of the second slot on the second UL panel, wherein K₁ plus K₂ is equal to N.

13-16. (canceled)
